(19) United States
(12) Patent Application Publication
(10) Pub. No.: US 2009/0254419 A1
(43) Pub. Date: Oct. 8, 2009

(54) INFORMATION DISPLAY SYSTEM, DISPLAY DEVICE, AND SERVER

(75) Inventors: Hiroki Mochizuki, Shizuoka (JP); Yoshihiko Ikeda, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/411,422

(22) Filed: Mar. 26, 2009

(30) Foreign Application Priority Data
Apr. 3, 2008 (JP) 2008-097326

(51) Int. Cl. G06Q 10/00; G05B 13/02; H04N 9/12

(52) U.S. Cl. 705/10; 700/276; 348/739

(57) ABSTRACT

An information display system includes plural display devices and a server. The plural display devices are arranged in a selling floor space. The display devices include measuring units. The measuring units measure environment characteristics and generate environment information based on results of the measurement. The display devices transmit the generated environment information to the server. The server generates environment distribution information of the selling floor space from the received environment information and position information of the respective display devices. The server distributes the environment distribution information to the respective display devices. The display devices display commodity information and the delivered environment distribution information together.

### CROSS REFERENCE TO RELATED APPLICATION

This application is based upon and claims the benefit of priority from Japanese Patent Application No. 2008-097326, filed on April 3, the content of which is incorporated herein by reference.

### TECHNICAL FIELD

The present invention relates to an information display system that is set in a shop and includes display devices such as electronic POP devices and electronic inventory tag devices that display commodity information such as prices, and the display devices and a server configuring the information display system.

### BACKGROUND

In the past, an information display system including display devices such as electronic POP devices and electronic inventory tag devices and a server is developed and installed in shops such as a supermarket. An example of the information display system is a price display system disclosed by Japanese Patent No. 3560988. The information display system includes display devices that are attached to commodity showcases and receive and display commodity information (names, prices, and the like of commodities) transmitted from the server. The information display system is useful for impressing customers with commodities.

Customers are becoming more interested in measures for energy saving in shops, the level of awareness of environment problems, and food management systems in the shops (e.g., under what kind of state fresh foods and processed foods are stored). Therefore, impressing the customers with measures for environment protection and food management systems in the shops is considered to improve satisfaction of the customers and improve a customer gathering effect.

### SUMMARY

It is an object of the present invention to impress customers with measures for environment protection and food management systems in shops.

According to an aspect of the present invention, there is provided a checkout system terminal including: plural display devices including display units that display information, first communication units that perform communication, measuring units that measure environment of a selling floor space and generate environment information, and storing units that store identification codes; a server including a second communication unit that performs communication and an arrangement-position storing unit that stores identification codes and arrangement positions in the selling floor space of the display devices specified by the identification codes in association with each other; control units that are included in the display devices and execute processing for causing the first communication units to transmit the identification codes for specifying the display devices and the environment information generated by the measuring units to the server in association with each other and processing for causing the display unit to display environment distribution information of the selling floor space received by the first communication units; and an information processing unit that is included in the server and generates, referring to the arrangement-position storing unit, the environment distribution information of the selling floor space from the identification codes and the environment information received by the second communication unit and causes the second communication unit to transmit the environment distribution information to the respective display devices.

According to another aspect of the present invention, there is provided a display device including: a display unit that displays information; a first communication unit that performs communication; a measuring unit that measures the environment of a selling floor space and generates environment information; and a control unit that executes processing for causing the first communication unit to transmit an identification code for specifying the display device and the environment information generated by the measuring unit in association with each other and processing for causing the display unit to display environment distribution information of the selling floor space generated on the basis of the transmitted identification code and environment information.

According to still another aspect of the present invention, there is provided a server including: a second communication unit that performs communication; an arrangement-position storing unit that stores identification codes and arrangement positions of display devices in the selling floor space specified by the identification codes in association with each other; and an information processing unit that executes processing for generating, referring to the arrangement-position storing unit, environment distribution information of the selling floor space from the identification codes and the environment information transmitted from the respective display devices set in the selling floor space and received by the second communication unit and processing for causing the second communication unit to transmit the environment distribution information to the respective display devices.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram of an overview of an information display system;

FIG. 2 is a block diagram of an electric configuration of the information display system;

FIG. 3 is a perspective view of a display device attached to a commodity showcase;

FIG. 4 is a schematic diagram of data of a measurement data recording file;

FIG. 5A is a schematic diagram of data of a tag arrangement position file;

FIG. 5B is a schematic diagram of an example of a method of designating an arrangement position in the tag arrangement position file;

FIG. 6 is a schematic diagram of data of a commodity data file;

FIG. 7A is a flowchart of a flow of processing for switching display content performed by a server;

FIG. 7B is a flowchart of a flow of processing for switching display content performed by the display device;

FIG. 8 is a flowchart of a flow of processing for generating environment distribution information; and

FIG. 9 is a flowchart of a flow of processing for controlling an adjusting apparatus.

### DETAILED DESCRIPTION

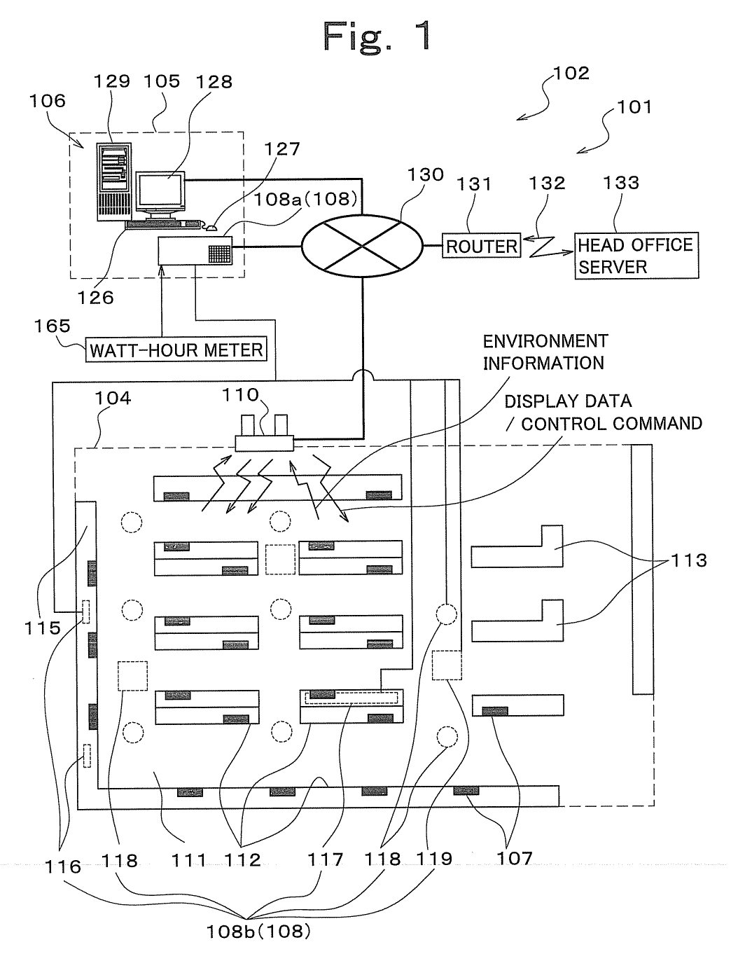

An embodiment of the present invention is explained with reference to FIGS. 1 to 9. In this embodiment, an example of application of the present invention to an information display system installed in a supermarket is explained.

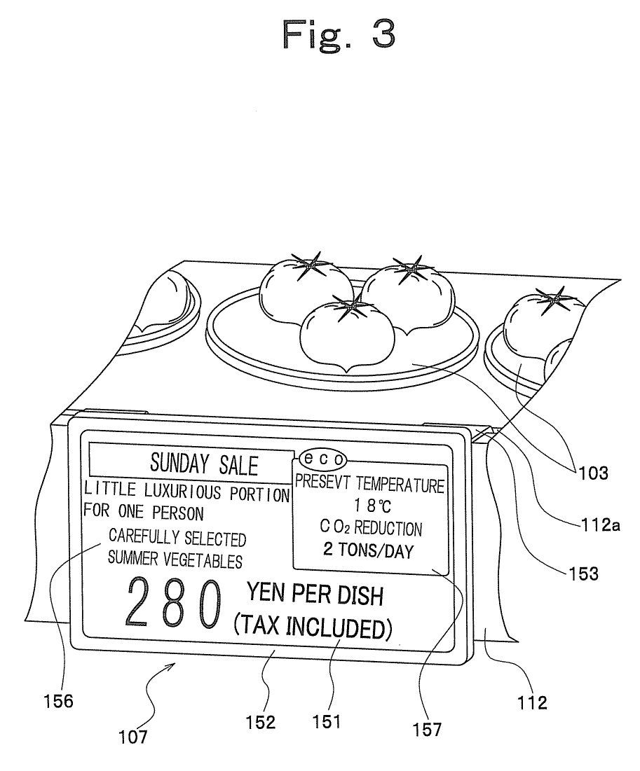

FIG. 1 is a schematic diagram of an overview of the information display system 101. A supermarket 102 is partitioned into a selling floor space 104 in which commodities 103 (see FIG. 3) are displayed and a backyard 105 to which salesclerks can feely come in and out. The information display system 101 according to this embodiment is installed in such a supermarket 102. The information display system 101 includes a server 106, display devices 107, an adjusting apparatus 108, and a radio access point 110. The adjusting apparatus 108 includes a control unit 108a and driving units 108b. The display devices 107, the driving units 108b, and the radio access point 110 are arranged in the selling floor space 104. The server 106 and the control unit 108a are arranged in the backyard 105. Examples of the driving units 108b include coolers 116, 117, lights 118, and air conditioners 119.

As shown in FIG. 1, commodity showcases 112 are set along an aisle 111 in the selling floor space 104. Checkout counters 113 for accounting are also set in the selling floor space 104. The display devices 107 are attached to the commodity showcases 112. The display devices 107 display commodity information 156 (see FIG. 3) concerning commodities 103 displayed on the commodity showcases 112. Plural kinds of commodity showcases 112 are set in the selling floor space 104. One of the commodity showcases 112 is a fresh fish showcase 115 for displaying seafood and meat. The cooler 116 for adjusting temperature and humidity in the fresh fish showcase 115 is attached to the fresh fish showcase 115. As one of the commodity showcases 112, there is also a not-shown showcase. The showcase includes the cooler 117 for cooling ice creams, ice, cakes, and the like. On the other hand, the lights 118 and the air conditioners 119 are attached to a ceiling (not shown) of the selling floor space 104. The lights 118 adjust the illuminance of the selling floor space 104. The air conditioners 119 adjust the temperature and the humidity of the selling floor space 104. The driving units 108b (the coolers 116 and 117, the lights 118, and the air conditioners 119) are driven according to the control by the control unit 108a and adjust the environment (temperature, humidity, illuminance, etc.) of the selling floor space 104.

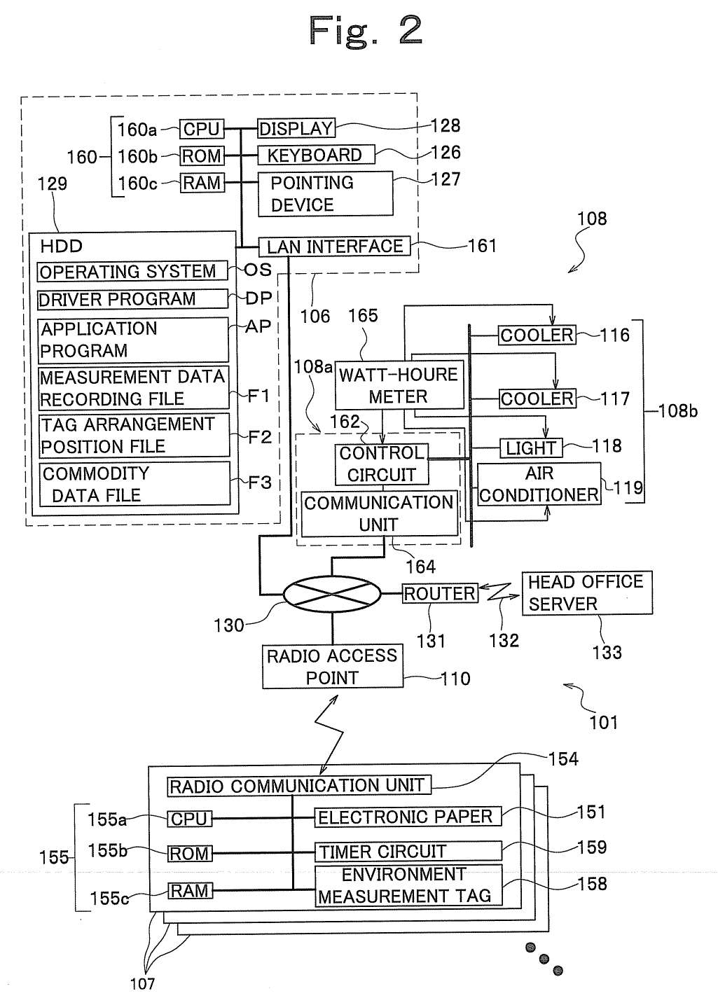

The server 106 is a computer apparatus and set in the backyard 105. The server 106 includes input devices such as a keyboard 126 and a pointing device 127, an output device such as a display 128, and a hard disk 129. The hard disk 129 stores an operating system OS and programs such as various driver programs DP and application programs AP. A CPU 160a (see FIG. 2) of the server 106 executes processing conforming to these kinds of programs. The hard disk 129 also stores various data files such as a measurement data recording file F1 (see FIG. 2).

The control unit 108a is set in the backyard 105 and connected to the driving units 108b. The control unit 108a is also connected to the server 106 through a LAN network 130 (explained later). The control unit 108a receives a control command transmitted from the server 106 and controls to drive the driving units 108b. In FIG. 1, a part of the connection between the control unit 108a and the driving units 108b (the coolers 116 and 117, the lights 118, and the air conditioners 119) is not shown. However, all of these units are connected. A watt-hour meter 165 (see FIG. 2) monitors power consumption of the driving units 108b and input power consumption to the control unit 108a.

The LAN network 130 is disposed in the supermarket 102. The LAN network 130 connects the server 106, the control unit 108a, and the radio access point 110 to freely perform data communication. The server 106 transmits display data, identification codes, and a control command to the display devices 107 and manages display performed on the display devices 107. The radio access point 110 receives the display data, the identification codes, and the control command transmitted from the server 106 and transmits the display data, the identification codes, and the control command to radio communication units 154 (see FIG. 3) of the display devices 107. The radio access point 110 receives environment information (explained later) transmitted from the display devices 107 and transmits the environment information to the server 106.

The server 106 performs data communication with a head office server 133 through the LAN network 130, a router 131, and a WAN network 132.

FIG. 2 is a block diagram of an electric configuration of the information display system 101. Each of the display devices 107 includes a microcomputer 155 as a control unit that controls the respective units of the display device 107. The microcomputer 155 includes a CPU 155a, a ROM 155b, and a RAM 155c. The CPU 155a executes arithmetic processing. The ROM 155b stores data including various programs. The CPU 155a performs various kinds of control processing on the basis of the programs stored in the ROM 155b. The RAM 155c can store plural display data displayed on an electronic paper 151.

The microcomputer 155 included in the display device 107 is connected to the electronic paper 151, the radio communication unit 154, and a timer circuit 159. The radio communication unit 154 receives display data and a control command transmitted from the radio access point 110 and outputs the display data and the control command to the microcomputer 155. The timer circuit 159 performs time measurement. The timer circuit 159 is used for adjusting timing when the CPU 155a performs processing for switching display data displayed on the electronic paper 151.

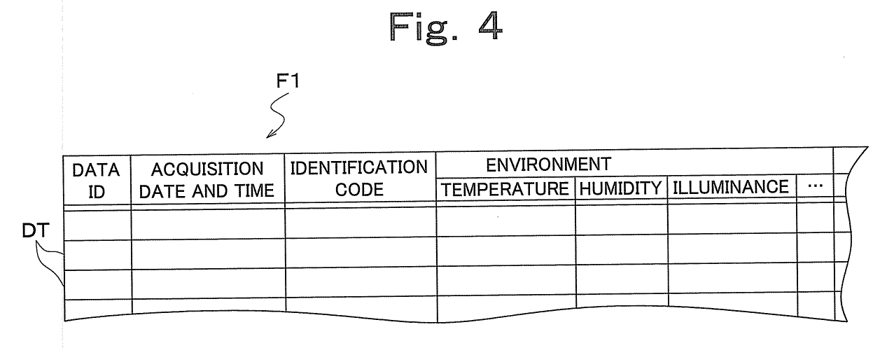

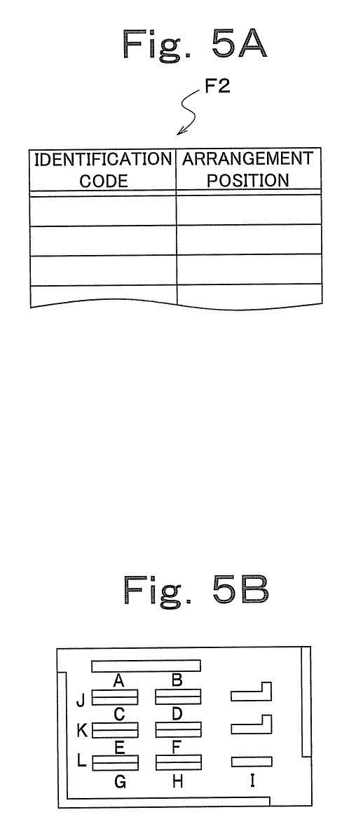

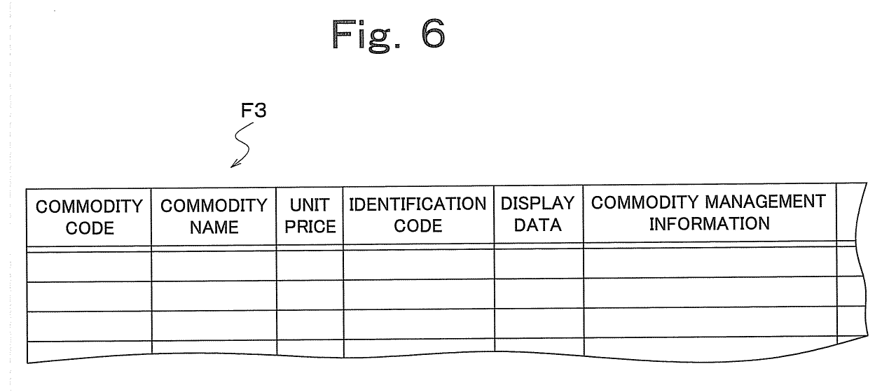

The server 106 includes an information processing unit 160 that executes information processing. The information processing unit 160 includes a CPU 160a, a ROM 160b, and a RAM 160c. The information processing unit 160 is connected to the keyboard 12b, the pointing device 127, the display 128, and a LAN interface 161. The LAN interface 161 functions as a second communication unit that connects the information processing unit 160 to the LAN network 130 and executes communication. The information processing unit 160 is further connected to the hard disk 129. The hard disk 129 stores various programs and various data files. The various programs include an operating system OS, a driver program DP, and various application programs AP. The various data files include a measurement data recording file F1 (see FIG. 4 as well), a tag arrangement position file F2 (see FIG. 5 as well), and a commodity data file F3 (see FIG. 6 as well). The CPU 160a performs various kinds of control on the basis of these programs.

The control unit 108a includes a control circuit 162 and a communication unit 164. The control circuit 162 includes a controller circuit (not shown) that controls to drive the driving units 108b and a nonvolatile storing unit (not shown) that stores data. The control circuit 162 is connected to the driving units 108b. The communication unit 164 realizes data communication between the control circuit 162 of the control unit 108a and the server 106.

The ROM 155b included in the display device 107 stores identification codes. The identification codes specify the respective display devices 107. The server 106 transmits display data, the identification code, and a control command to the display device 107. The radio communication unit 164 included in the display device 107 receives the display data, the identification code, and the control command via the radio access point 110.

The CPU 155a of the display device 107 displays the display data on the basis of the received control command when the received identification code and the identification code stored in the ROM 155b coincide with each other.

FIG. 3 is a perspective view of the display device 107 attached to the commodity showcase 112. The display device 107 is explained with reference to FIGS. 2 and 3. The display device 107 includes the electronic paper 151 as a display unit, a frame 152, a hook 153, the radio communication unit 154 as a first communication unit, the microcomputer 155 as a control unit, an environment measurement tag 158 as a measuring unit, and a battery (not shown). The frame 152 edges the electronic paper 151. The hook 153 is used for attaching the display device 107 to an attaching groove 112a provided in the commodity showcase 112. The radio communication unit 154 performs radio communication with the radio access point 110. The environment measurement tag 158 measures the environment (temperature, humidity, illuminance, etc.) around the display device 107 and generates environment information.

The display device 107 is attached to the front surface of the commodity showcase 112 with the hook 153 hooked to the attaching groove 112a of the commodity showcase 112. The radio communication unit 154, the microcomputer 155, and the environment measurement tag 158 are attached to the rear surface of the display device 107. The display device 107 transits the environment information to the server 106 together with the identification code stored in the ROM 155b. The server 106 generates environment distribution information (a temperature distribution, a humidity distribution, an illuminance distribution, etc.) in the selling floor space 104 on the basis of the received environment information. The server 160 delivers the environment distribution information to the respective display devices 107. The display device 107 displays the delivered environment distribution information as environment measures information 157. Since the environment measures information 157 is seen by shopping customers, the environment measures information 157 impresses the customers with measures for environment protection performed by the supermarket 102.

FIG. 4 is a schematic diagram of data in the measurement data recording file F1. The measurement data recording file F1 stores data records DT. The data records DT include acquisition date and time, the identification codes of the display devices 107, and environment information. The acquisition date and time indicates time when the environment information transmitted from the display devices 107 is input to the CPU 160a. The identification codes are codes transmitted in association with the environment information. The environment information includes a value of temperature, a value of humidity, and a value of illuminance. Data IDs are unique IDs and added to the data records DT.

FIG. 5A is a schematic diagram of data in the tag arrangement position file F2. FIG. 5B is a schematic diagram of an example of a method of designating an arrangement position in the tag arrangement position file F2. The tag arrangement position file F2 stores arrangement positions in association with the identification codes allocated to the display devices 107, respectively. The arrangement positions indicate in which positions in the selling floor space 104 the display devices 107 are arranged. The tag arrangement position file F2 is an arrangement-position storing unit. As an example, as shown in FIG. 5B, when the selling floor space 104 is divided into predetermined areas A to L in advance, the tag arrangement position file F2 stores, as arrangement positions, signs A to L of the areas A to L to which the display devices 107 belong.

FIG. 6 is a schematic diagram of data in the commodity data file F3. The commodity data file F3 stores, in association with commodity codes, names and unit prices of commodities specified by the commodity codes, the identification codes of the display devices 107 that display commodity information of the commodities, and display data and commodity management information displayed on the display device 107. The commodity codes specify the commodities 103 sold in the selling floor space 104. The commodity management information indicates environment information suitable for commodities. For example, the commodity management information is storage temperatures set for respective foods.

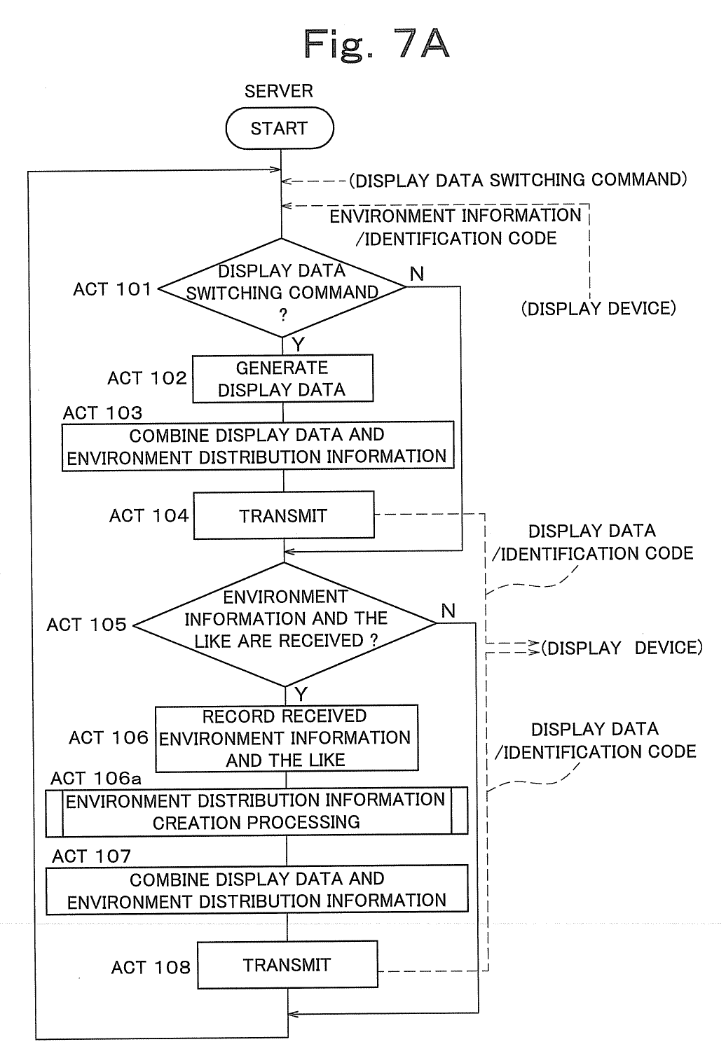

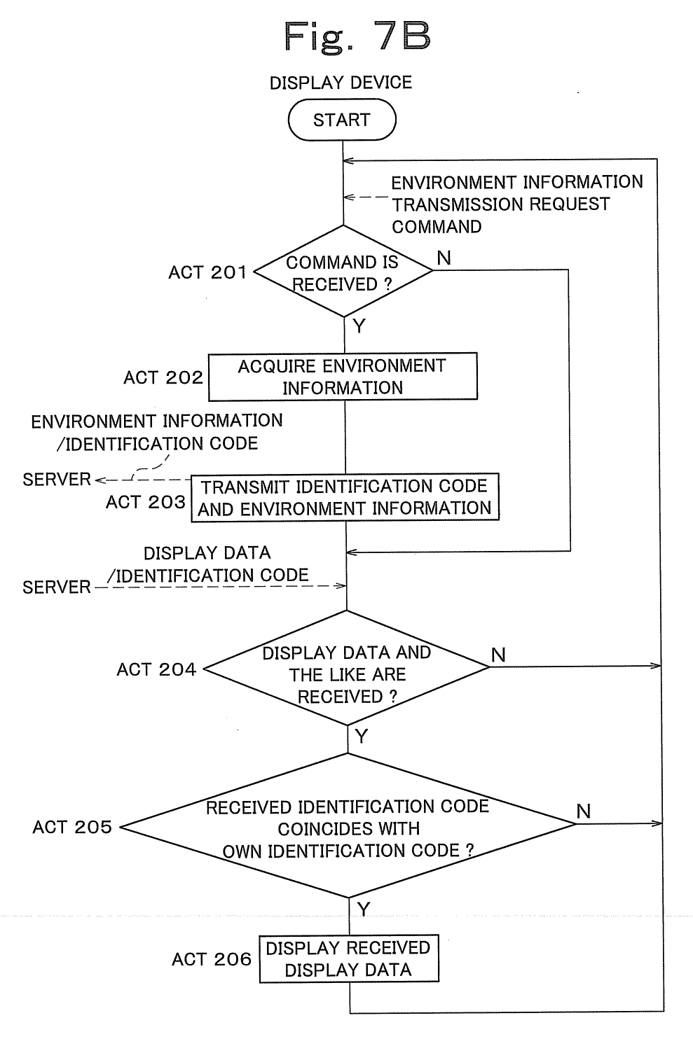

The information display system 101 executes processing explained with reference to FIGS. 7A and 7B to FIG. 9.

FIG. 7A is a flowchart of a flow of processing for switching display content of the display device 107 performed by the server 106. FIG. 7B is a flowchart of a flow of processing for switching display content of the display device 107 performed by the display device 107. First, referring to FIG. 7A, the CPU 160a of the server 106 stands by for input of a display data switching command for switching display content of the display device 107 (Act 101). As an example, the display data switching command is input from the keyboard 126 or the pointing device 127. As another example, the display data switching command is input according to reception of a control command transmitted from the head office server 133. The display data switching command involves designation of a commodity code of a commodity as a switching target of a switching command and the identification of the display device 107 as a switching target.

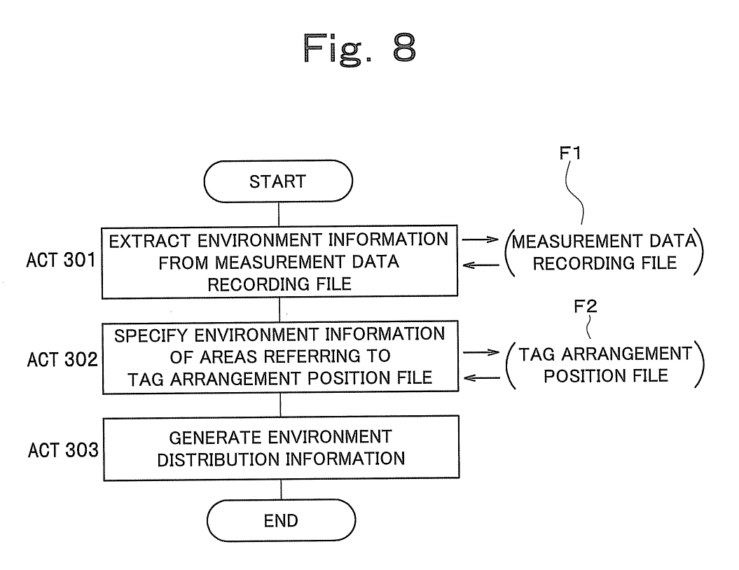

When the display data switching command is not input (N in Act 101), the CPU 160a proceeds the processing to Act 105. On the other hand, when the display data switching command is input (Y in Act 101), the CPU 160a generates display data of the commodity as the switching target of the display data switching command (Act 102). More specifically, in Act 102, the CPU 160a acquires, referring to the commodity data file F3, display data corresponding to a commodity code of a commodity, commodity information of which is about to be displayed on the display device 107 (see FIG. 6). The CPU 160a combines the display data generated in Act 102 with an upper layer of the environment distribution information (explained later with reference to FIG. 8) stored in the RAM 160c (Act 103). Subsequently, the CPU 160a transmits the display data after the layer combination to the display device 107 together with the identification code of the display device 107 as the switching target of the display data (Act 104). As another embodiment, the CPU 160a may repeat, while switching the identification code, the series of operations in Act 102 to Act 104 to switch the display of the display device 107.

The CPU 160a stands by for reception of the environment information and the identification code transmitted from the display device 107 (Act 105). When the environment information and the identification code are not received (N in Act 105), the CPU 160a returns the processing to Act 101. On the other hand, when the environment information and the identification code are received (Y in Act 105), the CPU 160a records the received environment information and the identification code in the measurement data recording file F1 (Act 106) and executes environment distribution information creation processing (explained later with reference to FIG. 8) (Act 106a). Subsequently, the CPU 160a combines the environment distribution information (explained later with reference to FIG. 8) stored in the RAM 160c with the display data from an upper layer of the display data (Act 107). The CPU 160a transmits the display data after the combination to the display unit 107 together with the identification code of the display device 107 as the switching target of the display data (Act 108) and returns the processing to Act 101. As another embodiment, the CPU 160a may switch the identification code and combine display data and the environment distribution information (Act 107), transmit these display data (Act 108), and switch the display of the display device 107.

Referring to FIG. 7B, the CPU 155a of the display device 107 stands by for reception of an environment information transmission request command transmitted from the server 106 (Act 201). When the environment information transmission request command is not input (N in Act 201), the CPU 155a proceeds the processing to Act 204. When the environment information transmission request command is input (Y in Act 201), the CPU 155a acquires environment information (a value of temperature, a value of humidity, a value of illuminance, etc.) from the environment measurement tag 158 (Act 202). The CPU 155a transits the acquired environment information and the identification code stored in the ROM 155b to the server 106 (Act 203) and proceeds the processing to Act 204. As another embodiment, the CPU 155a may proceed the processing from Y in Act 201 to Act 202 at a periodic interval (e.g., 10 minutes) according to time measurement by the timer circuit 159, switch the identification code to acquire environment information, and transmit these kinds of acquired environment information to the server 106 in association with the identification code, respectively.

As processing following N in Act 201 or Act 203, the CPU 155a stands by for reception of the display data transmitted from the server 106 (Act 204). When the display data is not received (N in Act 204), the CPU 155a returns the processing to Act 201. On the other hand, when the display data is received (Y in Act 204), the CPU 155a determines whether the identification code transmitted together with the display data coincides with the identification code stored in the ROM 155b (Act 205). When the identification codes do not coincide with each other (N in Act 205), the CPU 155a returns the processing to Act 201. When the identification codes coincide with each other (Y in Act 205), the CPU 155a displays the received display data on the electronic paper 151 (Act 206) and returns the processing to Act 201.

FIG. 8 is a flowchart of a flow of processing for generating environment distribution information. The CPU 160a of the server 106 performs this processing as processing following Act 106 shown in FIG. 7. As another embodiment, the CPU 160a may execute the processing for generating environment distribution information at a predetermined periodic interval (e.g., 15 minute interval).

First, the CPU 160a accesses the measurement data recording file F1 and extracts environment information stored therein (Act 301). As an example, for each of the areas A to L (see FIG. 5), the CPU 160a extracts, referring to the acquisition date and time of the measurement data recording file F1, latest environment information (temperature, humidity, illuminance, etc.) of the respective areas recorded last.

The CPU 160a specifies, referring to the tag arrangement position file F2, which environment information in which of the areas A to L of the selling floor space 104 the extracted environment information is (Act 302). The CPU 160a generates environment distribution information in the selling floor space 104 on the basis of the specified environment information of the areas A to L (Act 303). The CPU 160a stores the generated environment distribution information in the RAM 160c and finishes the series of processing.

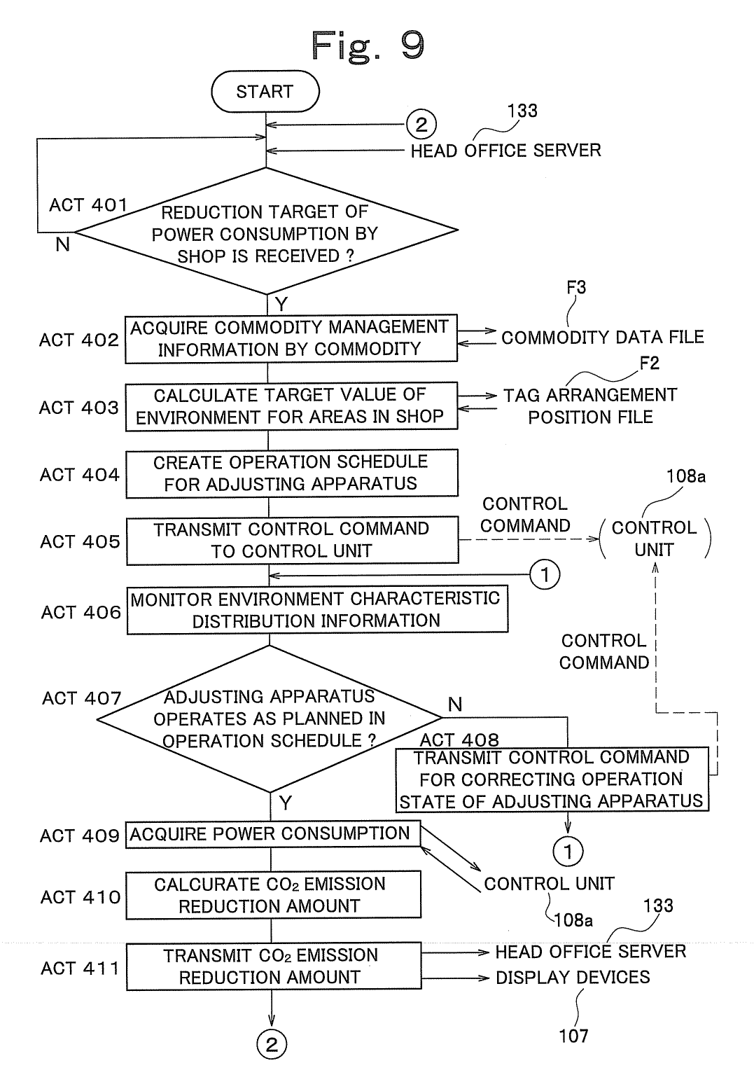

FIG. 9 is a flowchart of a flow of processing for controlling the adjusting apparatus 108 performed by the server 106. The CPU 160a of the server 106 stands by for reception of a reduction target of power consumption transmitted from the head office server 133 (Act 401).

The head office server 133 transmits reduction target of power consumption allocated to each of shops to the shops. When the reduction target of power consumption is received (Y in Act 401), the CPU 160a acquires, referring to the commodity data file F3, commodity management information corresponding to the commodity codes of the commodities 103 sold in the selling floor space 104 (Act 402). Subsequently, the CPU 160a specifies reduction targets of power consumption for the areas A to L in the shop referring to the commodity management information acquired in Act 402 and the data stored in the tag arrangement position file F2. The CPU 160a calculates target values of environment information (environment control target values) for the areas A to L from the reduction targets of power consumption (Act 403) and creates an operation schedule for controlling the adjusting apparatus 108 such that the targets are attained in the areas A to L (Act 404).

The CPU 160a transmits a control command for attaining the operation schedule created in Act 404 to the control unit 108a (Act 405). The control unit 108a controls to drive, according to the control command received by the communication unit 164, the driving units 108b (the coolers 116, the showcases 117, the lights 118, and the air conditioners 119) as planned in the operation schedule.

As processing following Act 405, the CPU 160a monitors the environment distribution information stored in the RAM 160c (Act 406) and determines whether the environment of the selling floor space 104 changes as planned in the operation schedule (Act 407). When the CPU 160a determines that the environment does not change as planned in the operation schedule (N in Act 407), the CPU 160a transmits a control command for correcting an operation state of the adjusting apparatus 108 to the control unit 108a (Act 408) and returns the processing to Act 406.

On the other hand, when the CPU 160a determines in Act 407 that the environment changes as planned in the operation schedule (Y in Act 407), the CPU 160a transmits, to the control unit 108a, a request signal for requesting the control unit 108a to transit power consumption input from the watt-hour meter 165 to the server 106 (Act 408). The CPU 160a acquires power consumption according to reception of the power consumption transmitted from the control unit 108a (Act 409). The CPU 160a calculates a difference between the power consumption acquired in Act 409 and power consumed when the adjusting apparatus 108 is driven against the control command and calculates a CO2 emission reduction amount on the basis of this difference (Act 410). The power consumed when the adjusting apparatus 108 is driven against the control command is power consumption stored in advance in the nonvolatile storing unit (not shown) included in the control unit 108a.

As a method of calculating a CO2 emission reduction amount, as an example, it is possible to use a method of calculating a CO2 emission reduction amount by multiplying power consumption with a carbon dioxide emission coefficient set for each fuel. As processing following Act 410, the CPU 160a transmits the calculated CO2 emission reduction amount to the head office server 133 and the display devices 107 (Act 411). After finishing the processing in Act 411, the CPU 160a of the server 106 returns the processing to Act 401.

When the CPU 155a of the display device 107 receives the CO2 emission reduction amount transmitted from the server 106, the CPU 155a displays the received CO2 emission reduction amount on the electronic paper 151 as the environment measures information 157. When an information processing unit (not shown) of the head office server 133 receives the CO2 emission reduction amount transmitted from the server 106, the information processing unit stores, in association with shop codes by shop, information concerning the received CO2 emission reduction amount in a database for storing CO2 emission reduction amounts by shop.

The information display system 101 configured as explained above is installed in the supermarket 102. The plural display devices 107 arranged to be distributed in the selling floor space 104. The environment measurement tag 158 attached to the display device 107 measures the environment (temperature, humidity, illuminance, etc.) around the display device 107 and generates environment information based on a result of the measurement. The display device 107 transmits, periodically or when it is determined that an environment information transmission request command from the server 106 is received, the environment information to the server 106 together with the identification code for specifying the display device 107. The server 106 receives the environment information from the display device 107 and stores the environment information in the measurement data recording file F1. The server 106 generates, referring to the measurement data recording file F1 stored in the environment information and the tag arrangement position file F2 for recording an arrangement position of the environment measurement tag 158, environment distribution information indicating a distribution state of the environment (temperature, humidity, and illuminance) in the selling floor space 104 and stores the environment distribution information in the RAM 160c. The environment distribution information is displayed, together with the commodity information 156, on the display device 107 attached to the commodity showcase 112 and attracts attention of shopping customers.

As an example, in FIG. 3, the electronic paper 151 of the display device 107 displays, not only the commodity information 156, a message “eco, present temperature 18° C., CO2 emission reduction amount 2 tons/day” as the environment measures information 157. Displayed temperature may be average temperature of the entire shopping floor space 104 or may be temperature around the commodity showcase 112 in which the display device 107 is set. It is also possible to display a value of reduced power consumption instead of the CO2 emission reduction amount.

As another example of the environment measures information 157, the display device 107 may create a distribution chart concerning various environments such as a temperature distribution, a humidity distribution, and an illuminance distribution in the selling floor space 104, transmit the distribution chart to the display device 107, and cause the display device 107 to display the distribution chart.

In the information display system 101 according to this embodiment, the server 106 transmits a control command based on a measurement result of measured environment to the adjusting apparatus 108 and controls to drive the adjustment apparatus 108 to bring the environment into a desired target state. Therefore, the information display system 101 according to this embodiment enables the adjusting apparatus 108 to perform an optimum operation leading to energy saving in the selling floor space 104.

In impressing customers with measures for environment protection and a food management system in the supermarket 102, the information display system 101 according to this embodiment can be applied to the display devices 107 already installed in the supermarket 102. In other words, it is unnecessary to build a new sensor network in the supermarket 102. Impressing customers with measures for environment protection and a food management system in this way improves reliability of the shop and contributes to an increase in customers.

Obviously, numerous modifications and variations of the present invention are possible in light of the above teachings. It is therefore to be understood that within the scope of the appended claims, the invention may be practiced otherwise than as specifically described herein.

What is claimed is:

1. A checkout system, comprising:
plural display devices including display units that display information, first communication units that perform communication, measuring units that measure environment of a selling floor space and generate environment information, and storing units that store identification codes;
a server including a second communication unit that performs communication and an arrangement-position storing unit that stores identification codes and arrangement positions in the selling floor space of the display devices specified by the identification codes in association with each other;
control units that are included in the display devices and execute processing for causing the first communication units to transmit the identification codes for specifying the display devices and the environment information generated by the measuring units to the server in association with each other and processing for causing the display unit to display environment distribution information of the selling floor space received by the first communication units; and
an information processing unit that is included in the server and generates, referring to the arrangement-position storing unit, the environment distribution information of the selling floor space from the identification codes and the environment information received by the second communication unit and causes the second communication unit to transmit the environment distribution information to the respective display devices.

2. The checkout system of claim 1, wherein the information processing unit of the server generates a control command for controlling to drive an adjusting apparatus and causes the second communication unit to transmit the control command to the adjusting apparatus, the adjusting apparatus adjusting, on the basis of the identification codes and the environment information received by the second communication unit, the environment information to bring the environment of the selling floor space into a desired target state.

3 The checkout system of claim 2, wherein
the information processing unit of the server calculates a difference between power consumption input from a watt-hour meter, which monitors the adjusting apparatus driven according to the control command, and power consumption stored in the storing units in advance as power consumed when the adjusting apparatus is driven against the control command and causes the second communication unit to transmit a CO2 emission reduction amount calculated on the basis of the difference to the respective display devices, and
the control units of the display devices cause the display units to display the CO2 emission reduction amount received by the first communication units.

4. A display device comprising:
a display unit that displays information;
a first communication unit that performs communication;
a measuring unit that measures environment of a selling floor space and generates environment information; and
a control unit that executes processing for causing the first communication unit to transmit an identification code for specifying the display device and the environment information generated by the measuring unit in association with each other and processing for causing the display unit to display environment distribution information of the selling floor space generated on the basis of the transmitted identification code and environment information.

5. The display device of claim 4, wherein the control unit causes the display unit to display a CO2 emission reduction amount received by the first communication unit.

6. A server comprising:
a second communication unit that performs communication;
an arrangement-position storing unit that stores identification codes and arrangement positions in the selling floor space of display devices specified by the identification codes in association with each other; and
an information processing unit that executes processing for generating, referring to the arrangement-position storing unit, environment distribution information of the selling floor space from the identification codes and the environment information transmitted from the respective display devices set in the selling floor space and received by the second communication unit and processing for causing the second communication unit to transmit the environment distribution information to the respective display devices.
